(19) United States
(12) Patent Application Publication
(10) Pub. No.: US 2026/0221315 A1
(43) Pub. Date: Jul. 30, 2026

(54) REMOVABLE CABLE CLIP

(71) Applicant: AFL Telecommunications LLC, Duncan, SC (US)

(72) Inventor: Leigh Flaherty, Duncan, SC (US)

(21) Appl. No.: 19/148,606

(22) PCT Filed: Jan. 11, 2024
(86) PCT No.: PCT/US2024/011182

§ 371 Date: Jul. 16, 2025

Related U.S. Application Data
(60) Provisional application No. 63/440,266, filed on Jan. 20, 2023.

(51) Int. Cl. H01B 7/36; G09F 3/00; G09F 3/06; G09F 3/20

(52) U.S. Cl. CPC H01B 7/368; G09F 3/0297; G09F 3/06; G09F 3/205

(57) ABSTRACT

A cable clip equipped with an identifying element for removably attaching to a cable is provided. A cable clip for attaching to a cable includes a flag label having at least one identifying element that corresponds to an identification code associated with the cable assembly. The cable clip further includes a clip assembly comprising an attachment body configured to be removably attached to the cable and a lock body configured to lock the clip assembly to the cable. The clip assembly is configured to be slidably adjustable when it is attached to the cable by the attachment body.

### FIELD

The present disclosure relates generally to removable cable clips, such as for identifying a cable.

### BACKGROUND

Application of identifying elements, such as near-field communication (NFC) tags, quick response (QR) codes, or barcode labels, to cable assemblies is a necessity in network communications. One such environment is in fiber optics, and in particular, in fiber optic cables in data centers. In such environments, a significant number of fiber optic cables can be found throughout the data center. Fiber optic cables must be identifiable to enable the retrieval of information during or after set-up of the data center. Typically, identifying elements are attached to the cables to provide information such as a reference number, which can be used to obtain relevant information corresponding to the cable or a group of cables (e.g. a cable assembly).

Current techniques for attaching identifying elements to small-diameter cables includes attaching a NFC tag or QR code with heat shrink to the cable during manufacture of the cable. The heat shrink cannot easily be applied, adjusted, or removed in the field once it has been applied to the cable. Forming an NFC tag to wrap around the cables is ineffective because the NFC tag cannot bend to the small circumference of the cable and QR codes printed on the cable are ineffective because the QR code cannot be scanned successfully.

Accordingly, improved apparatus for identifying cables is desired in the art and would be advantageous. In particular, identifying elements which provide the ability to be removably attached to cables would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a cable clip for attaching to a cable is provided. The cable clip includes a flag label having at least one identifying element that corresponds to an identification code associated with the cable assembly. The cable clip further includes a clip assembly comprising an attachment body configured to be removably attached to the cable and a lock body configured to lock the clip assembly to the cable. The clip assembly is configured to be slidably adjustable when it is attached to the cable by the attachment body.

In accordance with another embodiment, a cable clip for attaching to a cable is provided. The cable clip includes a flag label having at least one identifying element that corresponds to an identification code associated with the cable assembly. The cable clip further includes a clip assembly comprising an attachment body configured to be removably attached to the cable. The attachment body has a slide channel configured to receive the cable through an attachment opening defined by the slide channel. The clip assembly further comprises a lock body configured to lock the clip assembly to the cable. The lock body has a lock channel configured to receive the cable through a lock opening defined by the lock channel. The clip assembly is formed as a unitary structure comprising the attachment body and the lock body, with the lock opening being disposed between the slide channel and the lock channel. The clip assembly is slidably adjustable when attached to the cable by the attachment body.

In accordance with another embodiment, a clip assembly is provided. The cable clip includes a cable and a cable clip that is removably attached to the cable. The cable clip includes a flag label having at least one identifying element that corresponds to an identification code associated with the cable. The cable assembly further includes a clip assembly having an attachment body configured to be removably attached to the cable and a lock body configured to lock the cable clip to the cable. The clip assembly is configured to be slidably adjustable when it is attached to the cable by the attachment body.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a cable clip in accordance with embodiments of the present disclosure;

FIG. 2A is a cable clip in accordance with embodiments of the present disclosure;

FIG. 2B is a cross-section view of a cable clip in accordance with embodiments of the present disclosure;

FIG. 3A is a side-profile view of an attachment body in accordance with embodiments of the present disclosure;

FIG. 3B is a side-profile view of a lock body in accordance with embodiments of the present disclosure;

FIG. 4 is a cable clip in accordance with embodiments of the present disclosure;

FIG. 5A is a side-profile view of a clip assembly in accordance with embodiments of the present disclosure;

FIG. 5B is a side-profile view of a clip assembly in accordance with embodiments of the present disclosure;

FIG. 6 is a cross-section view of a lock body in accordance with embodiments of the present disclosure;

FIG. 7 is a cable assembly in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present) and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, a cable clip houses an identifying element and is configured to be removably attached to a cable. The cable clip can have flag label that carries the identifying element, such as a near-field communication tag, a quick response code, or a barcode label, which may be scanned to connect to a database and retrieve or otherwise provide information related to the cable or a cable assembly. The cable clip includes a clip assembly that is configured to fit onto the cable in a manner that allows the clip assembly to slide along and/or rotate about the cable. The clip assembly is further configured to lock onto the cable such that the clip assembly can retain a position relative to the cable (e.g., prevents sliding or rotating movement) without damaging the cable or any contents carried therein. In this way, identifying elements can easily be applied to and removed from small-diameter cables. The clip assembly can slide or rotate while remaining attached to the cable such that the position of identifying elements can be adjusted relative to the cable. Additionally, the clip assembly can lock onto the cable to retain the identifying elements at a desired position relative to the cable. The clip assembly may provide such functionality using a two-piece structure or a unitary structure.

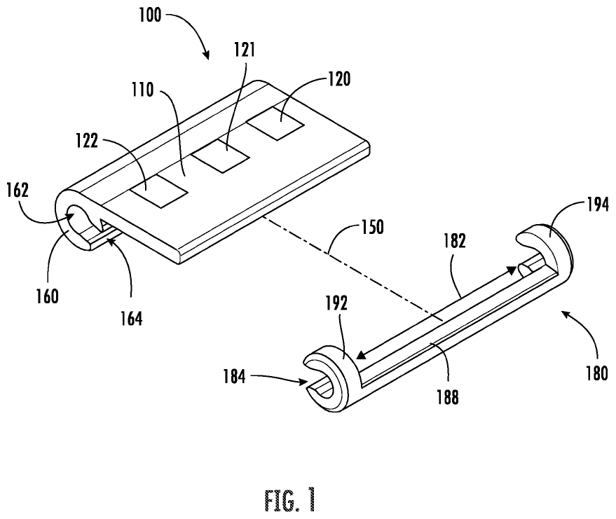

Referring now to the drawings, FIG. 1 illustrates a cable clip 100 in accordance with embodiments of the present disclosure. The cable clip 100 can generally include a flag label 110 having at least one identifying element 120 that corresponds to an identification code associated with a cable. In some instances, the flag label 110 may include a plurality of identifying elements 120, 121, 122 including for example QR codes, NFC chips, barcode labels, or a combination thereof. In some embodiments, the cable clip 100 may be configured with the flag label 110 having at least one identifying element 120 corresponding to an identification code for a group of cables (e.g., a cable assembly).

In some embodiments, the cable clip 100 can include a clip assembly 150 for applying the identifying element 120 housed by the flag label 110 onto a cable or a group of cables (e.g., cable assembly). The clip assembly 150 may include an attachment body 160 configured to be removably attached to the cable. In some embodiments, the attachment body 160 includes a slide channel 162 extending along a length of the attachment body 160. The slide channel 162 can define an attachment opening 164 that extends the length of the attachment body 160 to allow the attachment body 160 to clip on and/or attach to the cable. For example, the slide channel 162 can be configured to receive the cable through the attachment opening 164 such that the slide channel 162 at least partially encloses the cable when the attachment body 160 is attached to the cable. The cable can be removed from the slide channel 162 through the attachment opening 164. In this way, the attachment body 160 is configured to be removably attached to the cable.

In some embodiments, the clip assembly may include a lock body 180 for securing the cable clip 100 to the cable. In some instances, the lock body 180 may include a first lock clip 192 connected to a second lock clip 194 by a lock bar 188 with the first lock clip 192 and the second lock clip 194 being positioned at opposite ends of the lock bar. The first lock clip 192 and the second lock clip 194 each may define a clip opening for attaching the lock body 180 to a cable. According to one embodiment, the lock body 180 may have a lock channel 182 configured to receive the cable through a lock opening defined by the lock channel 182. For example, the lock opening may be defined by the clip openings of the first lock clip 192 and the second lock clip 194. In such instances, the lock channel 182 can be defined along the lock bar 188 including the clip openings of the first lock clip 192 and the second lock clip 194. The lock body 180 may include a projection extending from an interior wall of the lock bar 188.

In some embodiments, the clip assembly may be configured or otherwise provided as a two-piece structure with the attachment body 160 and the lock body 180 being formed as separate pieces. The flag label 110 of the cable clip 100 may be included with, formed on, or connected to one piece of the two-piece clip, such as the attachment body 160. The cable clip 100 can be removably attached to the cable by the attachment body 160. Further, the lock body 180 can be configured to clip onto the cable to lock the cable clip 100 onto the cable. In such instances, at least a portion of the lock bar 188, such as the projection extending from the interior wall of the lock bar 188, may extend through the attachment opening 164 of the slide channel 162. In some instances, the projection may extend into the slide channel 162. The first lock clip 192 and the second lock clip 194 may be positioned adjacent to the slide channel 162 of the attachment body 160.

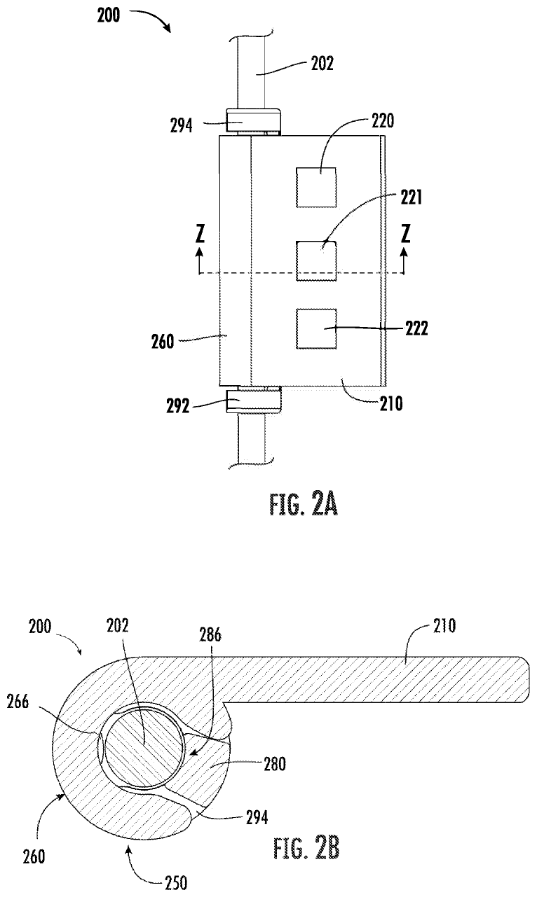

FIGS. 2A and 2B illustrate a top view and a cross-section view, respectively, of a cable clip 200 attached to a cable 202 in accordance with embodiments of the present disclosure. As depicted in FIG. 2A, the cable clip 200 may include a flag label 210 for housing at least one identifying element 220 or a plurality of identifying elements 220, 221, 222 corresponding to an identification code associated with the cable 202 or with a group of cables (e.g., a cable assembly). The cable clip 200 may include a clip assembly having an attachment body 260 that is configured to be removably attached to the cable 202. The clip assembly can be slidably adjusted or rotatably adjusted when attached to the cable 202 by the attachment body 260. The clip assembly may further include a lock body 280 that locks the clip assembly to the cable 202 to retain the clip assembly in a locked position. A cross-sectional view of the cable clip 200 along line Z-Z is depicted in FIG. 2B.

As depicted in FIG. 2B, the attachment body 260 may have one or more ridges 266 protruding from an interior wall of the attachment body 260. The one or more ridges 266 can extend into a slide channel 262 through which the cable 202 passes. In this way, the one or more ridges 266 are able to increase friction with the cable 202 in a way that allows for slidable and rotatable adjustments to the clip assembly while also restricting movement after an adjustment is made.

In some embodiments, the lock body 280 may clip onto the cable 202 to retain the clip assembly in a locked position. The lock body 280 may have a lock bar extending between two lock clips (e.g., lock clip 294). The lock bar may have a projection 286 extending from an interior wall of the lock bar to restrict movement of the cable clip 200. In some instances, the projection 286 may be in contact with the cable 202 when the lock body 280 is attached to the cable 202.

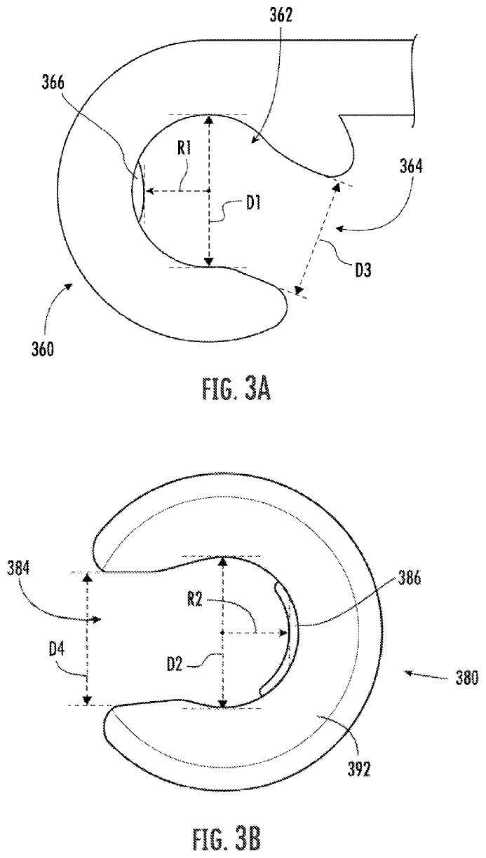

FIG. 3A illustrates a side profile view of an attachment body 360 in accordance with embodiments of the present disclosure. The attachment body 360 may include a slide channel 362 for receiving a cable through an attachment opening 364 defined by the slide channel 362. The attachment body 360 may include one or more ridges 366 extending from an interior wall of the attachment body 360 into the slide channel 362. The relative features of the attachment body 360 may be configured to have dimensions based at least in part on an outer diameter of the cable (“cable OD”) with which the cable clip is being applied. For example, the slide channel 362 may have a diameter D1 defined between two opposite points of the interior wall of the attachment body 360. The attachment opening 364 may have a diameter D3 defined by the slide channel 362. The slide channel 362 may have a radius R1 defined between the one or more ridges and a center point of the slide channel 362.

In some embodiments, the diameter D1 of the slide channel 362 may be greater than the cable OD. For example, D1 may be greater than the cable OD by between about 10% and about 50%, between about 15% and about 45%, between about 20% and about 40%, or between about 25% and about 35% of the cable OD. In some embodiments, D1 may be greater than the cable OD by less than about 10%, less than about 5%, or less than about 1% of the cable OD. In some embodiments, the diameter D3 of the attachment opening 364 may be less than the cable OD. For example, D3 may be less than the cable OD by between about 10% and about 50%, between about 15% and about 45%, between about 20% and about 40%, or between about 25% and about 35% of the cable OD. In some embodiments, D3 may be less than the cable OD by less than about 10%, less than about 5%, or less than about 1% of the cable OD. In some embodiments, the radius R1 between the one or more ridges and the center point of the slide channel 362 may be less than one half of the diameter of the slide channel 362. For example, R1 may be less than one half of the diameter D1 by between about 10% and about 50%, between about 15% and about 45%, between about 20% and about 40%, or between about 25% and about 35% of the diameter D1. In some embodiments, R1 may be less than one half of the diameter D1 by less than about 10%, less than about 5%, or less than about 1% of the cable OD.

FIG. 3B illustrates a side profile view of a lock body 380 in accordance with embodiments of the present disclosure. The lock body 380 may include a lock channel 382 for receiving a cable through a lock opening defined by the lock channel 382. The lock body 380 may include a lock bar connecting a first lock clip and a second lock clip (e.g., lock clip 392). In some embodiments, the lock body 380 includes a projection 386 extending from an interior wall of the lock bar into the lock channel 382. The relative features of the lock body 380 may be configured to have dimensions based at least in part on an outer diameter of the cable (“cable OD”) with which the cable clip is being applied. For example, the lock channel 382 may have a diameter D2 defined between two opposite points of the interior wall of the first and second lock clips (e.g., lock clip 392). The lock opening may have a diameter D4 defined by the lock channel 382. The lock channel 382 may have a radius R2 defined between the projection 386 and a center point of the slide channel 362.

In some embodiments, the diameter D2 of the lock channel 382 may be greater than the cable OD. For example, D2 may be greater than the cable OD by between about 10% and about 50%, between about 15% and about 45%, between about 20% and about 40%, or between about 25% and about 35% of the cable OD. In some embodiments, D2 may be greater than the cable OD by less than about 10%, less than about 5%, or less than about 1% of the cable OD. Referring to FIG. 3A, the slide channel 362 may have a diameter D1 that is greater than the diameter D2 of the lock channel 382. In some embodiments, the diameter D4 of the lock opening may be less than the cable OD. For example, D4 may be less than the cable OD by between about 10% and about 50%, between about 15% and about 45%, between about 20% and about 40%, or between about 25% and about 35% of the cable OD. In some embodiments, D4 may be less than the cable OD by less than about 10%, less than about 5%, or less than about 1% of the cable OD. Referring to FIG. 3A, the attachment opening 364 may have a diameter D3 that is greater than the diameter D4 of the lock opening. In some embodiments, the radius R2 between the projection 386 and the center point of the lock channel 382 may be less than one half of the diameter of the lock channel 382. For example, R2 may be less than one half of the diameter D2 by between about 10% and about 50%, between about 15% and about 45%, between about 20% and about 40%, or between about 25% and about 35% of the diameter D2. In some embodiments, R1 may be less than one half of the diameter D2 by less than about 10%, less than about 5%, or less than about 1% of the cable OD.

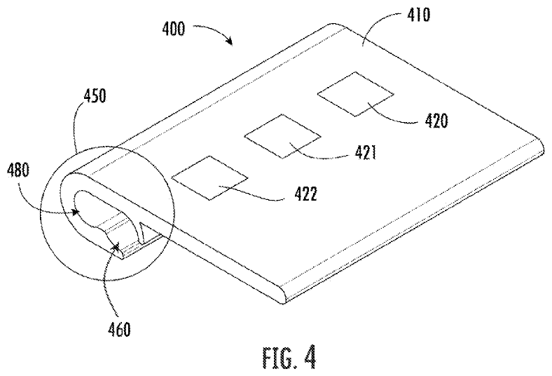

FIG. 4 illustrates a cable clip 400 in accordance with embodiments of the present disclosure. The cable clip 400 can generally include a flag label 410 having at least one identifying element 420 that corresponds to an identification code associated with a cable. In some instances, the flag label 410 may include a plurality of identifying elements 420, 421, 422 including for example QR codes, NFC chips, barcode labels, or a combination thereof. In some embodiments, the cable clip 400 may be configured with the flag label 410 having at least one identifying element 420 corresponding to an identification code for a group of cables (e.g., a cable assembly).

In some embodiments, the cable clip 400 can include a clip assembly 450 for applying the identifying element 420 housed by the flag label 410 onto a cable or a group of cables (e.g., cable assembly). The clip assembly 450 may include an attachment body 460 configured to be removably attached to the cable. In some embodiments, the attachment body 460 includes a slide channel 462 extending along a length of the attachment body 460. The slide channel 462 can be configured to receive the cable through an attachment opening 464 defined by the slide channel 462, as will be discussed in further detail. In some embodiments, the clip assembly may include a lock body 480 for securing the cable clip 400 to the cable. The lock body 480 may have a lock channel 482 configured to receive the cable through a lock opening defined by the lock channel 482, as will be discussed in further detail.

As depicted in FIG. 4, the clip assembly may be configured or otherwise provided as a unitary, monolithic structure comprising the attachment body 460 and the lock body 480. In such instances, the flag label 410 of the cable clip 400 may be included with, formed on, or connected to the clip assembly. The cable clip 400 can be removably attached to the cable by the attachment body 460. Further, the lock body 480 can be configured to receive the cable from the attachment body 460 to retain the clip assembly in a locked position.

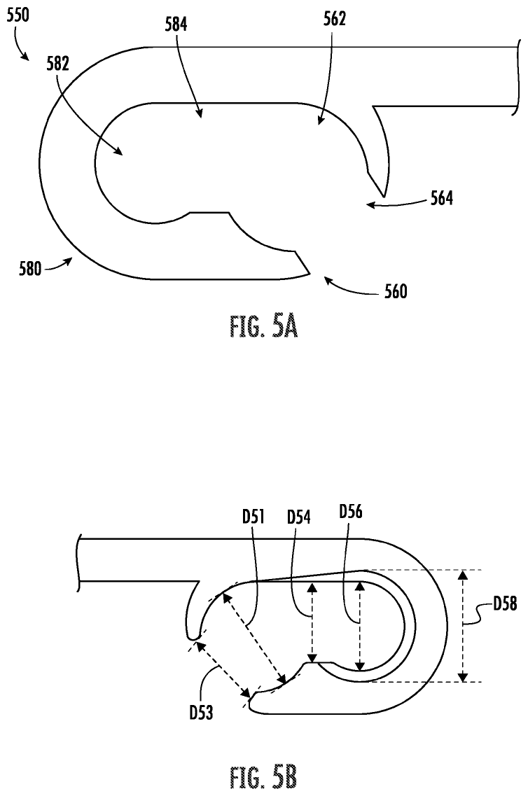

FIGS. 5A and 5B illustrate a first side-profile view and a second side-profile view, respectively, of a clip assembly in accordance with embodiments of the present disclosure. Referring to FIG. 5A, the clip assembly may include an attachment body 560 configured to be removably attached to a cable. In some embodiments, the attachment body 560 includes a slide channel 562 and an attachment opening 564 defined by the slide channel 562. The attachment body 560 may be configured to clip on and/or attach to the cable. For example, the slide channel 562 can be configured to receive the cable through the attachment opening 564 such that the slide channel 562 at least partially encloses the cable when the attachment body 560 is attached to the cable. The cable can be removed from the slide channel 562 through the attachment opening 564. In this way, the attachment body 560 is configured to be removably attached to the cable. The clip assembly may be slidably or rotatably adjusted when attached to the cable by the attachment body 560.

In some embodiments, the clip assembly may include a lock body 580 for securing the cable clip to the cable. In some instances, the lock body 580 may include a lock channel 582 configured to receive the cable through a lock opening defined by the lock channel 582. For example, the lock opening may be disposed between the slide channel 562 and the lock channel 582 such that the cable can be received by the lock body 580 from the slide channel 562. The lock body 580 may be configured to retain the clip assembly at a lock position when the cable is attached to the lock body 580. In some embodiments, the lock channel 582 may have a locking portion having a first diameter and a non-locking portion having a second diameter that is greater than the first diameter.

Referring to FIG. 5B, the relative features of the attachment body 560 and the lock body 580 may be configured to have dimensions based at least in part on an outer diameter of the cable (“cable OD”) with which the cable clip is being applied. For example, the slide channel 562 may have a diameter D51 defined between two opposite points of the interior wall of the attachment body 560. The attachment opening 564 may have a diameter D53 defined by the slide channel 562.

In some embodiments, the diameter D51 of the slide channel 562 may be greater than the cable OD. For example, D51 may be greater than the cable OD by between about 10% and about 50%, between about 15% and about 45%, between about 20% and about 40%, or between about 25% and about 35% of the cable OD. In some embodiments, D51 may be greater than the cable OD by less than about 10%, less than about 5%, or less than about 1% of the cable OD. In some embodiments, the diameter D53 of the attachment opening 564 may be less than the cable OD. For example, D53 may be less than the cable OD by between about 10% and about 50%, between about 15% and about 45%, between about 20% and about 40%, or between about 25% and about 35% of the cable OD. In some embodiments, D53 may be less than the cable OD by less than about 10%, less than about 5%, or less than about 1% of the cable OD. In this way, the diameter D51 of the slide channel 562 allows the cable clip to move freely along the cable when the clip assembly is attached to the cable by the attachment body 560. Further, the diameter D53 of the attachment opening 564 is large enough to allow a cable to be received through the attachment opening 564 while also preventing the cable clip from freely detaching from the cable.

As discussed with reference to FIG. 5A, the lock body 580 includes a lock channel 582 configured to receive the cable from the attachment body 560 through the lock opening defined by the lock channel 582. As will be discussed in detail below, the lock channel 582 may have a locking portion and a non-locking portion. The relative features of the lock body 580 may be configured to have dimensions based at least in part on an outer diameter of the cable (“cable OD”) with which the cable clip is being applied. As depicted in FIG. 5B, the locking portion may have a first diameter D56 and the non-locking portion may have a second diameter D58. The lock opening may have a diameter D54 defined by the lock channel 582.

In some embodiments, the second diameter D58 may be about the same as the diameter D51 of the attachment body 560. For example, D58 may be greater than the cable OD by between about 10% and about 50%, between about 15% and about 45%, between about 20% and about 40%, or between about 25% and about 35% of the cable OD. In some embodiments, D58 may be greater than the cable OD by less than about 10%, less than about 5%, or less than about 1% of the cable OD. The locking portion of the lock channel 582 has a first diameter that is less than the second diameter. For example, the first diameter D56 may be less than the second diameter D58 by between about 10% and about 50%, between about 15% and about 45%, between about 20% and about 40%, or between about 25% and about 35% of the second diameter D58. In some embodiments, D56 may be less than the second diameter D58 by less than about 10%, less than about 5%, or less than about 1% of the second diameter D58. In this way, the non-locking portion of the lock channel 582 allows the lock channel 582 to receive the cable without applying excessive force on the cable or otherwise damaging the cable while the locking portion of the lock channel 582 retains the cable clip in a locked position. In some embodiments, the diameter D54 of the lock opening may be less than the cable OD. For example, D54 may be less than the cable OD by between about 10% and about 50%, between about 15% and about 45%, between about 20% and about 40%, or between about 25% and about 35% of the cable OD. In some embodiments, D54 may be less than the cable OD by less than about 10%, less than about 5%, or less than about 1% of the cable OD.

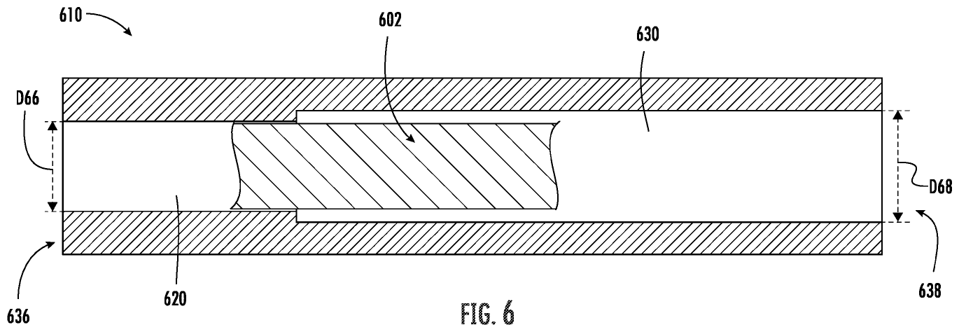

FIG. 6 illustrates a cross-section view of a lock body 610 in accordance with one or more embodiments of the present disclosure. In some embodiments, the lock body 610 includes a lock channel for retaining a cable 206 in a locked position when attached to the lock body 610. The lock channel can include a locking portion 620 having a first diameter D66 and a non-locking portion 630 having a second diameter D68, the first diameter D66 being less than the second diameter D68. The locking portion 620 and the non-locking portion 630 can have different lengths measured from a first end 636 of the lock channel and a second end 638 of the lock channel. For instance, the locking portion 620 may have a first length extending from the first end 636 of the lock channel and the non-locking portion 630 may have a second length extending from a second end 638 of the lock channel. In some examples, the first length may be less than the second length. In this way, the non-locking portion 630 of the lock channel allows the lock channel to receive the cable 602 without applying excessive force on the cable 602 or otherwise damaging the cable 602 while the locking portion 620 of the lock channel retains the cable clip in a locked position.

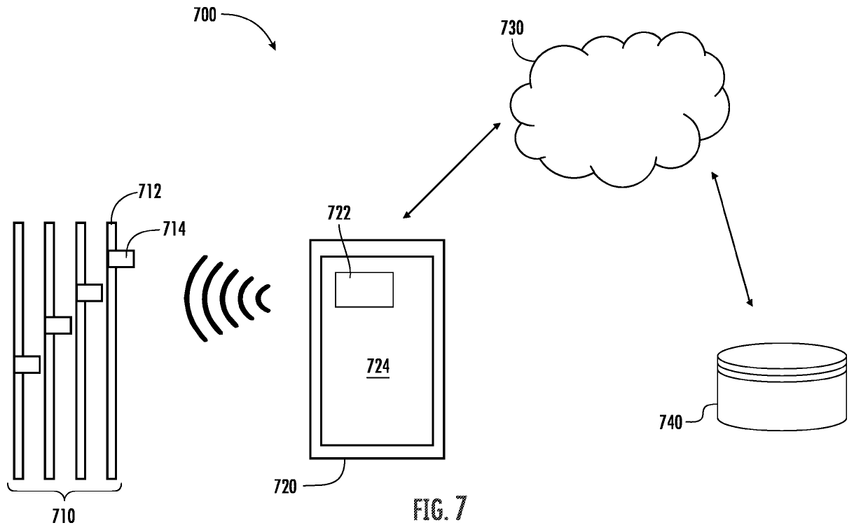

FIG. 7 illustrates a cable assembly 710 of a communication network 700 in accordance with embodiments of the present disclosure. As shown, the communication network 700 includes the cable assembly 710. The cable assembly 710 may comprise a plurality of cables (e.g., cable 712) with each cable 712 having a cable clip 714 attached thereto. The cable clip 714 may include a flag label having at least one identifying element corresponding to an identification code associated with the cable 712. The identifying element may be at least one of an NFC tag, a QR code, and/or a barcode label. The cable clip 714 may have a clip assembly comprising an attachment body configured to be removably attached to the cable 712 and a lock body configured to lock the cable clip 714 to the cable 712. The clip assembly can be slidably adjustable when attached to the cable 712 by the attachment body. Further, the clip assembly may be provided as a two-piece structure or as a unitary, monolithic structure, as previously described and in accordance with the disclosed embodiments.

The communication network 700 may comprise a scanning device 720. The scanning device 720 may include a scanner 722 configured to identify the identification code associated with the identifying element of the cable clip 714. In some embodiments, the scanning device 720 has a display screen 724 to provide information relating to the cable 712 or the cable assembly 710. For example, the scanning device 720 may be configured to communicate via a network link 730 with a database 740 to store and/or retrieve data related to the cable 712 or the cable assembly 710. For example, the information stored by the database 740 can include one or more fields, including for example, test data, database options, and data center setup information, associated with the cable 712 or the cable assembly 710. In some instances, the database 740 can be used to provide such data including one or more fields. For example, such information can be retrieved when a request from the scanning device 720 is communicated to the database via the network 730. The requested information can be communicated from the database 740 to the scanning device 720 via the network 730 to be displayed to a user on the display screen 724 of the scanning device 720.

Further aspects of the invention are provided by one or more of the following embodiments:

In accordance with one embodiment, a cable clip for attaching to a cable of a cable assembly is provided. The cable clip includes a flag label having at least one identifying element that corresponds to an identification code associated with the cable assembly. The cable clip further includes a clip assembly comprising an attachment body configured to be removably attached to the cable and a lock body configured to lock the clip assembly to the cable. The clip assembly is configured to be slidably adjustable when it is attached to the cable by the attachment body.

The cable clip of any one or more of the embodiments may include an attachment body having a slide channel configured to receive the cable through an attachment opening defined by the slide channel. The slide channel may have a diameter that is greater than a diameter of the attachment opening and a diameter of the cable.

The cable clip of any one or more of the embodiments may include a lock body with a lock channel configured to receive the cable through a lock opening defined by the lock channel. The clip assembly is configured to be retained in a locked position when attached to the cable by the lock body.

The cable clip of any one or more of the embodiments may have a clip assembly that is provided as a two-piece structure with the attachment body and the lock body being formed as separate pieces.

The cable clip of any one or more of the embodiments may include an attachment body that has one or more ridges protruding from an interior wall of the attachment body. In such instances, the one or more ridges can be configured to restrict movement of the cable when the attachment body is attached to the cable.

The cable clip of any one or more of the embodiments may have a lock body comprising a first lock clip connected to a second lock clip by a lock bar. The lock bar may include a projection extending from an interior wall of the lock bar to restrict the movement of the cable.

The cable clip of any one or more of the embodiments may include a lock body configured to clip onto the cable to lock the cable disposed inside the slide channel. In such embodiments, a portion of the lock bar may extend into the slide channel through the attachment opening with the first clip and the second clip being disposed adjacent to the slide channel of the attachment body.

The cable clip of any one or more of the embodiments may include a clip assembly that is a unitary structure comprising the attachment body and the lock body. In such embodiments, the lock body can have a lock channel configured to receive the cable through a lock opening defined by the lock channel.

The cable clip of any one or more of the embodiments may have a lock channel that includes a locking portion and a non-locking portion. In such embodiments, the locking portion may have a diameter that is less than a diameter of the non-locking portion.

The cable clip of any one or more of the embodiments may include a lock channel with a locking portion and a non-locking portion. The locking portion can have a first length extending from a first end of the lock channel and the non-locking portion can have a second length extending from a second end of the lock channel. In such embodiments, the first length may be less than the second length.

The cable clip of any one or more of the embodiments may have at least one scannable element including a near-field communication tag, a quick response code, or a barcode label.

In accordance with another embodiment, a cable clip for attaching to a cable of a cable assembly is provided. The cable clip includes a flag label having at least one identifying element that corresponds to an identification code associated with the cable assembly. The cable clip further includes a clip assembly comprising an attachment body configured to be removably attached to the cable. The attachment body has a slide channel configured to receive the cable through an attachment opening defined by the slide channel. The clip assembly further comprises a lock body configured to lock the clip assembly to the cable. The lock body has a lock channel configured to receive the cable through a lock opening defined by the lock channel. The clip assembly is formed as a unitary structure comprising the attachment body and the lock body, with the lock opening being disposed between the slide channel and the lock channel. The clip assembly is slidably adjustable when attached to the cable by the attachment body.

The cable clip of any one or more of the embodiments may include a slide channel having a diameter. The diameter of the slide channel may be greater than a diameter of the attachment opening and a diameter of the cable.

The cable clip of any one or more of the embodiments may have a lock body that includes a locking portion and a non-locking portion. In such embodiments, the locking portion can have a diameter that is less than a diameter of the non-locking portion.

The cable clip of any one or more of the embodiments may include a clip assembly that is retained at a first position relative to the cable when the clip assembly is attached to the cable by the locking portion of the lock body.

The cable clip of any one or more of the embodiments may include a lock body with a locking portion that has a first length extending from a first end of the lock channel and a non-locking portion has a second length extending from a second end of the lock channel. In such embodiments, the first length may be less than the second length.

The cable clip of any one or more of the embodiments may have at least one scannable element including a near-field communication tag, a quick response code, or a barcode label.

In accordance with another embodiment, a cable assembly is provided. The cable assembly includes a cable and a cable clip that is removably attached to the cable. The cable clip includes a flag label having at least one identifying element that corresponds to an identification code associated with the cable. The cable clip further includes a clip assembly having an attachment body configured to be removably attached to the cable and a lock body configured to lock the cable clip to the cable. The clip assembly is configured to be slidably adjustable when it is attached to the cable by the attachment body.

The cable assembly of any one or more of the embodiments may include a lock body having a first lock clip connected to a second lock clip by a lock bar. In such embodiments, the lock body may be configured to clip onto the cable.

The cable assembly of any one or more of the embodiments may include a clip assembly that is a unitary structure. In such embodiments, the unitary structure comprises the attachment body and the lock body.

The cable assembly of any one or more of the embodiments may have at least one scannable element including a near-field communication tag, a quick response code, or a barcode label.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A cable clip for attaching to a cable, the cable clip comprising:
a flag label having at least one identifying element corresponding to an identification code associated with the cable; and
a clip assembly comprising an attachment body configured to be removably attached to the cable and a lock body configured to lock the clip assembly to the cable, the clip assembly being slidably adjustable when attached to the cable by the attachment body.

2. The cable clip of claim 1, wherein the attachment body comprises a slide channel configured to receive the cable through an attachment opening defined by the slide channel, the slide channel having a diameter that is greater than a diameter of the attachment opening and a diameter of the cable.

3. The cable clip of claim 1, wherein the lock body comprises a lock channel configured to receive the cable through a lock opening defined by the lock channel, the clip assembly being retained in a locked position when attached to the cable by the lock body.

4. The cable clip of claim 1, wherein the clip assembly is provided as a two-piece structure with the attachment body and lock body being formed as separate pieces.

5. The cable clip of claim 1, wherein the attachment body comprises one or more ridges protruding from an interior wall of the attachment body, the one or more ridges being configured to restrict movement of the cable when the attachment body is attached to the cable.

6. The cable clip of claim 3, wherein the lock body comprises a first lock clip connected to a second lock clip by a lock bar having a projection extending from an interior wall of the lock bar to restrict movement of the cable.

7. The cable clip of claim 6, wherein the lock body is configured to clip onto the cable to lock the cable disposed inside the slide channel with at least a portion of the lock bar extending into the slide channel through the attachment opening, the first clip and the second clip being disposed adjacent to the slide channel of the attachment body.

8. The cable clip of claim 1, wherein the clip assembly is provided as a unitary structure comprising the attachment body and the lock body,
wherein the lock body comprises a lock channel configured to receive the cable through a lock opening defined by the lock channel.

9. The cable clip of claim 8, wherein the lock channel comprises a locking portion having a first diameter and a non-locking portion having a second diameter, the first diameter being less than the second diameter.

10. The cable clip of claim 9, wherein the locking portion has a first length extending from a first end of the lock channel and the non-locking portion has a second length extending from a second end of the lock channel, the first length being less than the second length.

11. The cable clip of claim 1, wherein the at least one identifying element is at least one of a near-field communication tag, a quick response code, or a barcode label.

12. A cable clip for attaching to a cable, the cable clip comprising:
a flag label having at least one identifying element corresponding to an identification code associated with the cable;
a clip assembly, the clip assembly comprising:
an attachment body configured to be removably attached to the cable, the attachment body comprising a slide channel configured to receive the cable through an attachment opening defined by the slide channel;
a lock body configured to lock the clip assembly to the cable, the lock body comprising a lock channel configured to receive the cable through a lock opening defined by the lock channel; and
wherein the clip assembly is provided as a unitary structure comprising the attachment body and the lock body, the lock opening being disposed between the slide channel and the lock channel,
wherein the clip assembly is slidably adjustable when attached to the cable by the attachment body.

13. The cable clip of claim 12, wherein the slide channel has a diameter that is greater than a diameter of the attachment opening and a diameter of the cable.

14. The cable clip of claim 12, wherein the lock channel comprises a locking portion having a first diameter and a non-locking portion having a second diameter, the first diameter being less than the second diameter.

15. The cable clip of claim 14, wherein the locking portion has a first length extending from a first end of the lock channel and the non-locking portion has a second length extending from a second end of the lock channel, the first length being less than the second length.

16. The cable clip of claim 12, wherein the at least one identifying element is at least one of a near-field communication tag, a quick response code, or a barcode label.

17. A cable assembly comprising:
a cable; and
a cable clip removably attached to the cable, the cable clip comprising:
a flag label having at least one identifying element corresponding to an identification code associated with the cable;
a clip assembly comprising an attachment body configured to be removably attached to the cable and a lock body configured to lock the cable clip to the cable, the clip assembly being slidably adjustable when attached to the cable by the attachment body.

18. The cable assembly of claim 17, wherein the lock body comprises a first lock clip connected to a second lock clip by a lock bar having a projection extending from an interior wall of the lock bar to restrict movement of the cable.

19. The cable assembly of claim 17, wherein the clip assembly is provided as a unitary structure comprising the attachment body and the lock body.

20. The cable assembly of claim 17, wherein the at least one identifying element is at least one of a near-field communication tag, a quick response code, or a barcode label.
